(19) United States
(12) Patent Application Publication
(10) Pub. No.: US 2010/0179927 A1
(43) Pub. Date: Jul. 15, 2010

(54) RATING RISK OF PROPOSED SYSTEM CHANGES

(75) Inventors: Sunil Meher, Risali (IN); Prasanna Nagarai, Hyderabad (IN)

Correspondence Address: SCHWEGMAN, LUNDBERG & WOESSNER, P.A., P.O. BOX 2938, MINNEAPOLIS, MN, 55402, US

(73) Assignee: CA, Inc., Islandia, NY (US)

(21) Appl. No.: 12/352,141

(22) Filed: Jan. 12, 2009

(51) Int. Cl. G06F 17/20; G06N 7/02

(52) U.S. Cl. 706/11; 706/52

(57) ABSTRACT

Various embodiments provide one or more of systems, methods, software, and data structures rate risk of proposed system changes. Some embodiments include receiving input representative of answers to a set of system change questions presented to a user and the answers representative of a proposed system change. A risk ranking of the proposed system change may then be derived based on the received system change question answers and a success factor will be identified based on the historical data. Further, a probability factor weightage indicative of an amount of data considered in identifying the success factor may be obtained. A risk rating is then calculated for making the proposed system change based on the risk ranking, success factor, and probability factor aspects of the proposed change, which helps in better change management.

### BACKGROUND INFORMATION

Computing environments are becoming ever-increasingly complex. Today's enterprises operate distributed computer networks that are heterogeneous and complex as the simple client-server architecture has given way to multi-tiered and distributed architectures. With this increasing complexity, there has been an associated increase in the difficulty for organizations to not only keep these systems functioning, but also to keep these systems functioning in an optimal manner. As a result, analysis of all changes to those systems is needed to identify both potential impact and the probability of the change success. This analysis may be referred to as risk assessment.

However, risk assessment is typically a human process that is prone to error. Different approaches have been implemented to identify risk levels, but most of these are provide a simple drop down for a human to select a subjective risk value. Other approaches have been based on simple Boolean questions to arrive at a value. However, these approaches are still very subjective and do not consider any information other than what a single individual has provided. As a result, the accuracy of the risk assessment approaches to date has been inaccurate.

### SUMMARY

Various embodiments include one or more of systems, methods, software, and data structures for risk rating of proposed system changes. One embodiment provides a method that may be performed by a computer. This method includes receiving input representative of answers to a set of system change questions presented to a user where the answers are representative of a proposed system change. A risk ranking of the proposed system change is then derived and a success factor identified based on the received system change question answers. A probability factor weightage is also obtained that is indicative of an amount of data considered in identifying the success factor. This method also includes calculating a risk rating for making the proposed system change based on the risk ranking, success factor, and probability factor. The risk ranking may then be stored in a memory of a computer performing the method.

Another embodiment is in the form of a system including both of at least one processor and of at least one memory device coupled to a bus. An instruction set is stored in at least one memory device. The instruction set is executable by the processor to receive input representative of answers to a set of system change questions presented to a user where the answers are representative of a proposed system change. The instruction set is further operable to derive a risk ranking of the proposed system change and identify a success factor based on the received system change question answers. The instruction set may include further instructions to obtain a probability factor weighting indicative of an amount of data considered in identifying the success factor and to calculate a risk rating for making the proposed system change based on the risk ranking, success factor, and probability factor.

### BRIEF DESCRIPTION OF THE DRAWINGS

FIG. 1 is a logical block diagram of a computing environment according to an example embodiment.

FIG. 2 is an illustration of a portion of a user interface according to an example embodiment.

FIG. 3 is a database table illustration according to an example embodiment.

FIG. 4 is a database table illustration according to an example embodiment.

FIG. 5 is a database table illustration according to an example embodiment.

FIG. 6 is a database table illustration according to an example embodiment.

FIG. 7 is a logical illustration of a data structure according to an example embodiment.

FIG. 8 is a block diagram of a method according to an example embodiment.

FIG. 9 is a block diagram of a computing device according to an example embodiment.

### DETAILED DESCRIPTION

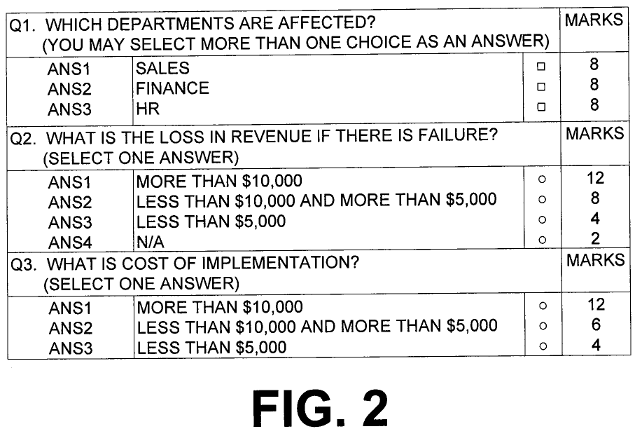

In some embodiments, rating risk of proposed system changes is performed using tree analysis, such as by using the tree-type data structure illustrated in FIG. 7. The tree analysis may be performed to identify and quantify risks based on aspects of risk assessment, such as the probability of success for changes and the potential impact of the proposed change. Some embodiments include performing a process that includes completion of a risk-based questionnaire, such as is illustrated in FIG. 2, for assessing the initial impact of the change. A probability factor indicative of a likely success rate for the change detailed through completion of the questionnaire is then determined using the historical information indicating success or failure of similar previous changes. Finally, the tree analysis approach is used to arrive at the final calculated risk rating value for the change request. These and other embodiments are described below with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. The following description is, therefore, not to be taken in a limited sense, and the scope of the inventive subject matter is defined by the appended claims.

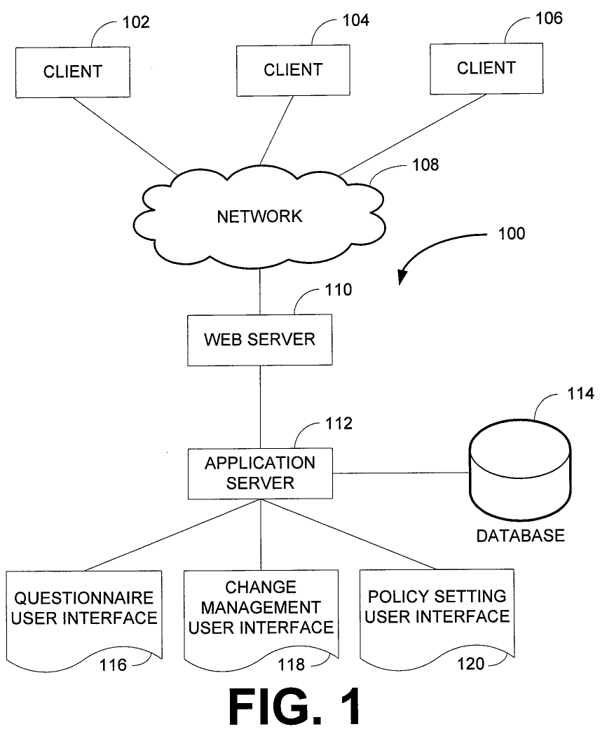

FIG. 1 is a logical block diagram of a computing environment 100 according to an example embodiment. The computing environment 100 typically includes a plurality of clients 102, 104, 106 connected to a network 108. The clients 102, 104, 106 may include personal computers and other computing devices, such as smart phones and handheld computing devices. The network 108 may include wired and wireless network connections to one or more networks such as the Internet, intranets, local area networks, system area networks, virtual private networks, and the like.

Also connected to the network 108 is a web server 110. The web server 110 may further be connected to an application server 112 having access to a database 114. One or more of the web server 110, the application server 112, and the database 114 may be implemented on a single physical computer, although they may be implement on individual or even distributed computing platforms. The web server 110, in some embodiments is operable to receive requests for content, such as a request for a risk-rating questionnaire. In such instances, the request may originate from one of the clients 102, 104, 106 over the network 108. The web server 110 will request a questionnaire web page from the application server 112. The application server 112 will service the request with content defining a questionnaire user interface 116 for display in a web browser or other program of the requesting client 102, 104, 106. The web server 112 forwards the content back to the requesting client 102, 104, 106 over the network 108.

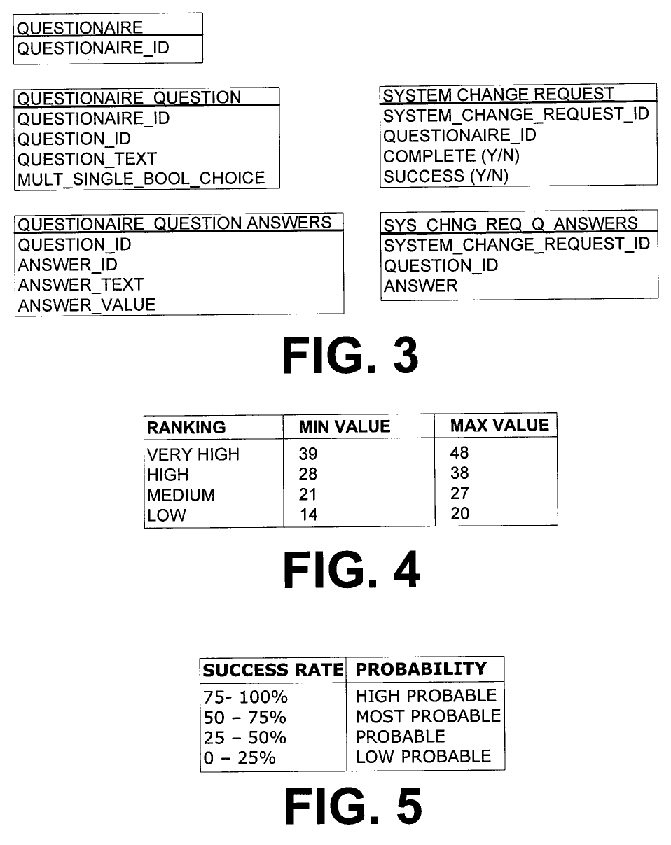

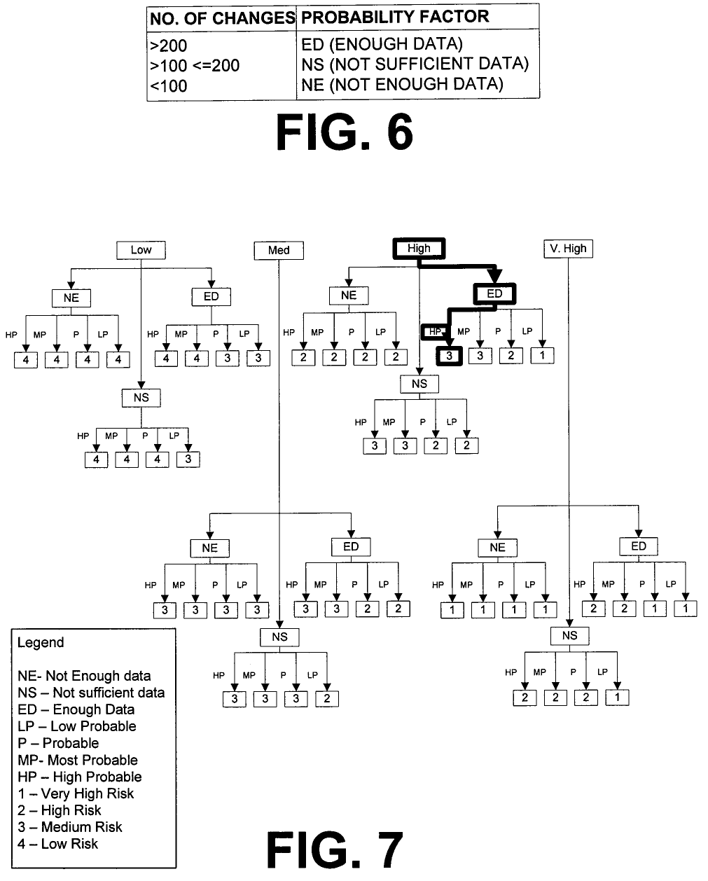

The client 102, 104, 106 will then display the questionnaire user interface 116 content on a display device, such as a monitor. The questionnaire user interface 116 is operable to receive input from a user regarding details of a requested system change. The requested system change may be a change to a particular client 102, 104, 106, to one of the illustrated elements of the system 100, or other hardware or software element of the system 100 that is not illustrated or that of another system. Upon receipt of the input, such as upon selection of a questionnaire user interface control to submit the system change data, data representative of the received input is transmitted by the client 102, 104, 106 over the network 108 to the application server which processes the data to rate the risk of performing the change detailed in the data. The application server 112 may rate the risk based on data stored in the database 114 and may also store the received data in the database. Other data may also be stored in the database 114, such as is illustrated in FIG. 3, FIG. 4, FIG. 5, and FIG. 6 as well as questionnaire questions and answers thereto.

The application server 112 may be further operable to provide a change management user interface 118 and a policy setting user interface 120 to requesting clients 102, 104, 106. The change management user interface 118, in some embodiments is operable to retrieve and display data detailing requested changes from the database 114, such as stored questionnaire answer data. The change management user interface 118 may also be operable to receive data indicating if a requested change was successful or not and to cause that data to be stored in the database. The policy setting user interface 120 may be operable to allow a user to create, modify, and delete questions of questionnaires and entire questionnaires that may be displayed via the questionnaire user interface 116.

FIG. 2 is an illustration of a portion of a user interface, such as the questionnaire user interface 116 of FIG. 1, according to an example embodiment. The illustrated user interface portion includes a set of questions with each question having defined answers. Some questions may allow for more than one answer, while other questions may allow only a single answer with two or more possible answers. The questions are typically targeted at assessing risk factors of a proposed system change. The questions may be numbered and sequenced and each answer may be scored by the response chosen. The goal of the question is typically to gauge the potential impact and complexity of a proposed system change. The questions may be dynamic, meaning the consecutive questions may change based on question responses. For example, if a question response indicates that the change is to a configuration of a sales software portion of a system, more questions may be presented with regard to the sales software portion while questions regarding hardware changes will not be presented. Each set of questions is typically defined by a system or application administrator based on the category or platform of requested change.

Multiple answers may be provided for questions and different weightage or marks for each of the multiple answers may be assigned. Then, based on responses received for the questions, an initial risk ranking may be calculated. By answering the questionnaire, users select answers and the associated marks/weightage of each selected answer are then summed. The sum will be drawn for each questionnaire by adding up the response values for the questions. Different sum ranges may be associated with different rankings, such as the rankings illustrated in the table of FIG. 4. Based on the sum of a completed questionnaire, the ranking is assigned.

Once the initial risk rating has been derived, a probability factor of doing a similar change is derived. The probability factor is derived, in some embodiments, based on historical data of success and failure of a category of similar changes. The category of similar change is identified based on the questionnaire answers. For instance, if a category of change and risk level is selected and the success rate for the change is found to be high, any such similar selection of change category and risk level would result in high probability of success for the change. In one embodiment, data indicative of success or failure is captured following implementation of a change for which a questionnaire was completed. The questionnaire answers may be stored in a database, such as a database having a schema as illustrated in FIG. 3. In one such embodiment, a universe of questionnaires including an indication of success or failure are identified in the database having similar answers as a questionnaire while closing of changes are under evaluation. Of the universe of questionnaires, a success rate percentage may be calculated. The success rate percentage may then be used as a key to identify a success factor, such as by selecting a success factor probability from a table such as is illustrated in FIG. 5.

At this point, a risk ranking and a success factor for a proposed change have been identified. However, these two values, alone or in combination, may not provide an accurate risk level rating. For example, if there have been very few changes made of the category of the proposed change, the data may be misleading. Thus, to provide further context to the final risk rating, a quantity of data factor, referred to as a probability factor, is combined with the risk ranking and the success factor.

The probability factor, in some embodiments, may be identified based on a total number of changes made in the category of the proposed change. As mentioned above, the category of the proposed change may be determined by identifying in the database questionnaires for which success or failure data is present that have similar answers as the questionnaire of the proposed change. A count of these questionnaires may be made and used as a key to retrieve a probability factor from a table, such as is illustrated in FIG. 6.

The risk ranking, success factor, and probability factor may then be used to identify a final risk rating. The risk rating is determined, in some embodiments, by performing a tree analysis based on the risk ranking, success factor, and probability factor. The risk ranking, success factor, and probability factor are used in the tree analysis to follow branches of a tree-like data structure, such as is illustrated in FIG. 7. The data structure of FIG. 7 is hierarchical in nature and may be stored in a database table, other data structure, or represented in computer code as will be readily apparent. The hierarchical data structure, in some embodiments, includes a number of levels equal to the number of factoring determinations made to obtain the risk rating, plus an additional level including the risk rating. For example, in the present embodiment, the data structure includes four levels, a level for each of the risk ranking, the success factor, and the probability factor, plus the additional level for the risk rating. Thus, other embodiments may include more factors and hierarchy levels in the rating and hierarchical data structure without departing from the scope of the inventive subject matter herein.

An example of rating risk for a proposed change may be as follows. A change requestor may complete the questionnaire of FIG. 2 with the following answers and associated marks:
Question 1: Ans1, Ans2 (8+8)
Question 2: Ans2 (8)
Question 3: Ans2 (6)
   The sum of the marks from these answers is 30. The value of 30 is used in this example to select a risk ranking from the table of FIG. 4. The value of 30 results in a risk ranking of HIGH due to value of 30 being in the range of 28 to 38. The risk ranking value ranges and rankings may be specified by an administrator. The value ranges and rankings, in some embodiments, may be specified as fixed values, percentages of a maximum possible value, or by other formulaic expressions.

A success factor is determined next. To determine the success factor, assume the category is a defined category explicitly based on a questionnaire answer. In this category, 300 changes have been made, of which 270 have been successful, or 90 percent. The value of 90 percent is used to select a success factor of HIGH PROBABLE from the table of FIG. 5. The total of 300 changes in the category is further used to select a probability factor of ED or ENOUGH DATA. The enough data value is indicative of there being enough data in the category to trust the data. The values of the data and the meaning can be varied in different embodiments by an administrator. The values for the various success factors may be determined in any number of ways that an administrator may desire or as specified by organizational policies. For example, a formula may be specified that identifies a number of changes made in a particular period, suchas as a previous quarter or previous year to obtain a count. The count may then be rated to obtain a success factor according to the same or different rule or policy. This is merely one example of how a success factor may be identified. Other embodiments may include this and other formulas.

The risk rating may then be calculated based on the risk ranking of HIGH, the success factor of HIGH PROBABLE using the success rate of similar changes in past, and the probability factor of ENOUGH DATA. These values are used to select a risk rating from the data structure of FIG. 7. The HIGH value first, the ENOUGH DATA value next, and the HIGH PROBABLE value after that. The result is a risk rating of 3, which equates to a Medium Risk as shown in the legend of FIG. 7. The risk rating may then be stored, displayed, or processed further, depending on the particular embodiment.

FIG. 3 is a database table illustration according to an example embodiment. The tables of FIG. 3 are an example of how questions, possible answers, and received answers to a questionnaire may be stored. The tables, such as the SYSTEM_CHANGE_REQUEST table and the SYS_CHNG_REQ_Q_ANSWERS table may also be utilized to store historical data that may be accessed to identify completed changes and success thereof to determine the success and probability factors as discussed above.

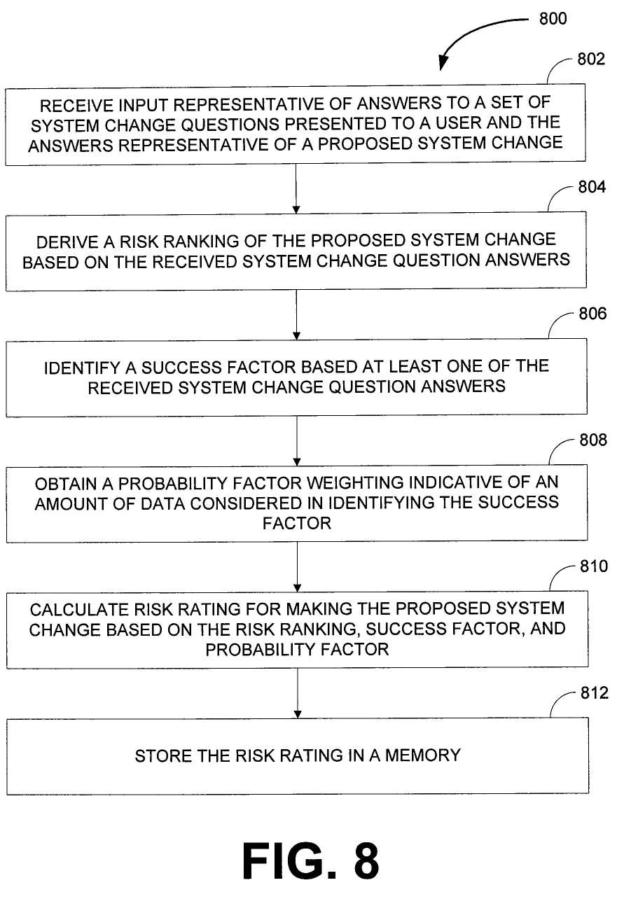

FIG. 8 is a block diagram of a method 800 according to an example embodiment. The method 800 is an example of a method that may be performed to determine a risk of making a proposed system change. The method includes receiving 802 input representative of answers to a set of system change questions presented to a user and the answers representative of a proposed system change. The method further includes deriving 804 a risk ranking of the proposed system change based on the received system change question answers and identifying 806 a success factor based at least one of the received system change question answers. Then the method may obtain 808 a probability factor weighting indicative of an amount of data considered in identifying the success factor. A risk rating of making the proposed change may then be calculated 810 based on the risk ranking, success factor, and probability factor. In some embodiments, the risk rating is then stored 812.

In some embodiments of the method 800, identifying 806 a success factor based at least one of the received system change question answers includes identifying a category of the proposed system change based on the at least one of the received system change question answers. A success rate of previous changes may then be obtained for the identified category. Such a success rate may be obtained by counting, in a database including historical data representative previous changes, a total number of completed system changes in the identified category. A number of completed system changes identified as being successfully completed in the identified category may also be counted. Once both counts have been made, such embodiments include calculating a percentage of successful changes based on the counted successful number of the counted total number of completed system changes in the identified category. This percentage is then used to selected, or otherwise obtain from a success factor.

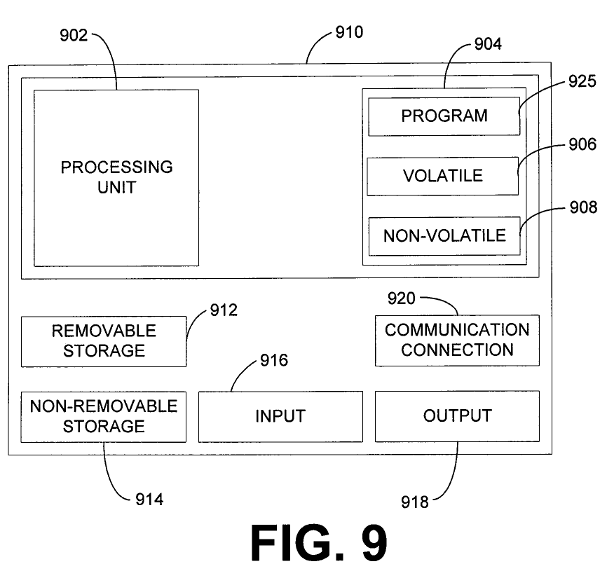

FIG. 9 is a block diagram of a computing device according to an example embodiment. In one embodiment, multiple such computer systems are utilized in a distributed network to implement multiple components in a transaction-based environment. An object-oriented, service oriented, or other architecture may be used to implement such functions and communicate between the multiple systems and components. One example computing device in the form of a computer 910, may include a processing unit 902, memory 904, removable storage 912, and non-removable storage 914. Memory 904 may include volatile memory 906 and non-volatile memory 908. Computer 910 may include—or have access to a computing environment that includes—a variety of computer-readable media, such as volatile memory 906 and non-volatile memory 908, removable storage 912 and non-removable storage 914. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 910 may include or have access to a computing environment that includes input 916, output 918, and a communication connection 920. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 902 of the computer 910. A hard drive, CD-ROM, and RAM are some examples of articles including a computer-readable medium. For example, a computer program 925 capable of performing one or more of the method described herein.

The various operations of example methods and processes described herein may be performed, at least partially, by one or more processing units 902 that are temporarily configured (e.g., by software) or permanently configured to perform the relevant operations. Whether temporarily or permanently configured, such processing units 902 may constitute processor-implemented modules that operate to perform one or more operations or functions. The modules referred to herein may, in some example embodiments, comprise processor-implemented modules.

Similarly, the methods and processes described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving input into a process that is executable by a computing device including at least one processor and a memory, the input representative of answers to a set of system change questions presented to a user and the answers representative of a proposed system change;
deriving a risk ranking of the proposed system change based on the received system change question answers;
identifying a success factor based at least one of the received system change question answers;
obtaining a probability factor weighting indicative of an amount of data considered in identifying the success factor;
calculating risk rating for making the proposed system change based on the risk ranking, success factor, and probability factor; and
storing the risk rating in the memory.

2. The method of claim 1, wherein:
each possible answer of system change question includes an associated ranking value; and
deriving the risk ranking of the proposed system change includes:
summing the risk ranking values associated with the input representative of each received answer to the system change questions; and
obtaining the risk ranking from a risk ranking table as a function of the sum of the risk ranking values.

3. The method of claim 1, wherein the questions of the set of system change questions include predefined answers that are presented to a user via a display of the computing device.

4. The method of claim 1, wherein identifying a success factor based at least one of the received system change question answers includes:
identifying a category of the proposed system change based on the at least one of the received system change question answers;
obtaining a success rate of previous changes made in the identified category.

5. The method of claim 4, wherein obtaining the success rate of previous changes made in the identified category includes:
counting, in a database including historical data representative previous changes, a total number of completed system changes in the identified category;
counting, in the database including the historical data representative of previous changes, a number of completed system changes identified as being successfully completed in the identified category;
calculating a percentage of successful changes based on the counted successful number of the counted total number of completed system changes in the identified category; and
selecting, from a success factor derivation table, the success factor based on the calculated percentage of successful changes.

6. The method of claim 1, wherein obtaining the probability factor weighting indicative of the amount of data considered in identifying the success factor includes:
identifying a category of the proposed system change based on the at least one of the received system change question answers;
counting, in a database including historical data representative previous changes, a total number of completed system changes in the identified category.

7. The method of claim 6, wherein obtaining the probability factor weighting indicative of the amount of data considered in identifying the success factor further includes:
identifying a probability factor that classifies the count of the total number of completed system changes in the identified category.

8. The method of claim 1, wherein calculating the risk rating for making the proposed system change includes:
selecting a risk rating from a hierarchical data structure including at least four levels, the levels including a level for each of the risk ranking, success factor, probability factor, and risk rating.

9. A computer-readable storage medium having a set of instructions stored thereon that are executable by a computer to perform a process, the process comprising:
receiving input representative of answers to a set of system change questions presented to a user and the answers representative of a proposed system change;
deriving a risk ranking of the proposed system change based on the received system change question answers;
identifying a success factor based at least one of the received system change question answers;
obtaining a probability factor weighting indicative of an amount of data considered in identifying the success factor;
calculating risk rating for making the proposed system change based on the risk ranking, success factor, and probability factor; and
storing the risk rating in a memory device.

10. The computer-readable storage medium of claim 9, wherein:
each possible answer of system change question includes an associated ranking value; and
deriving the risk ranking of the proposed system change includes:
summing the risk ranking values associated with the input representative of each received answer to the system change questions; and
obtaining the risk ranking from a risk ranking table as a function of the sum of the risk ranking values.

11. The computer-readable storage medium of claim 9, wherein the questions of the set of system change questions include predefined answers that are presented to a user via a display of the computing device.

12. The computer-readable storage medium of claim 9, wherein identifying a success factor based at least one of the received system change question answers includes:
identifying a category of the proposed system change based on the at least one of the received system change question answers;
obtaining a success rate of previous changes made in the identified category.

13. The computer-readable storage medium of claim 12, wherein obtaining the success rate of previous changes made in the identified category includes:
counting, in a database including historical data representative previous changes, a total number of completed system changes in the identified category;
counting, in the database including the historical data representative of previous changes, a number of completed system changes identified as being successfully completed in the identified category;
calculating a percentage of successful changes based on the counted successful number of the counted total number of completed system changes in the identified category; and
selecting, from a success factor derivation table, the success factor based on the calculated percentage of successful changes.

14. The computer-readable storage medium of claim 9, wherein obtaining the probability factor weighting indicative of the amount of data considered in identifying the success factor includes:
identifying a category of the proposed system change based on the at least one of the received system change question answers;
counting, in a database including historical data representative previous changes, a total number of completed system changes in the identified category.

15. The computer-readable storage medium of claim 14, wherein obtaining the probability factor weighting indicative of the amount of data considered in identifying the success factor further includes:
identifying a probability factor that classifies the count of the total number of completed system changes in the identified category.

16. A system comprising:
at least one processor coupled to a bus;
at least one memory device coupled to the bus;
an instruction set stored in the at least one memory device, the instruction set executable by the processor to:
receive input representative of answers to a set of system change questions presented to a user and the answers representative of a proposed system change;
derive a risk ranking of the proposed system change based on the received system change question answers;
identify a success factor based at least one of the received system change question answers;
obtain a probability factor weighting indicative of an amount of data considered in identifying the success factor;
calculate risk rating for making the proposed system change based on the risk ranking, success factor, and probability factor; and
store the risk rating in the at least one memory device.

17. The system of claim 16, wherein:
each possible answer of system change question includes an associated ranking value; and
deriving the risk ranking of the proposed system change includes:
summing the risk ranking values associated with the input representative of each received answer to the system change questions; and
obtaining the risk ranking from a risk ranking table as a function of the sum of the risk ranking values.

18. The system of claim 16, wherein identifying a success factor based at least one of the received system change question answers includes:
identifying a category of the proposed system change based on the at least one of the received system change question answers;
obtaining a success rate of previous changes made in the identified category.

19. The system of claim 18, wherein obtaining the success rate of previous changes made in the identified category includes:
counting, in a database including historical data representative previous changes, a total number of completed system changes in the identified category;
counting, in the database including the historical data representative of previous changes, a number of completed system changes identified as being successfully completed in the identified category;
calculating a percentage of successful changes based on the counted successful number of the counted total number of completed system changes in the identified category; and
selecting, from a success factor derivation table, the success factor based on the calculated percentage of successful changes.

20. The system of claim 16, wherein obtaining the probability factor weighting indicative of the amount of data considered in identifying the success factor includes:
identifying a category of the proposed system change based on the at least one of the received system change question answers;
counting, in a database including historical data representative previous changes, a total number of completed system changes in the identified category; and
identifying a probability factor that classifies the count of the total number of completed system changes in the identified category.
